(19) United States
(12) Patent Application Publication
(10) Pub. No.: US 2015/0324621 A1
(43) Pub. Date: Nov. 12, 2015

(54) RFID HANDHELD DEVICE FOR READING RFID INFORMATION

(71) Applicant: SICK AG, Waldkirch (DE)

(72) Inventors: Jurgen REICHENBACH, Waldkirch (DE); Martin SCHENK, Waldkirch (DE); Bernhard MULLER, Waldkirch (DE)

(21) Appl. No.: 14/699,003

(22) Filed: Apr. 29, 2015

(30) Foreign Application Priority Data
May 6, 2014 (DE) 102014107400.9

(51) Int. Cl. G06K 7/10

(52) U.S. Cl. CPC G06K 7/10386; G06K 7/10356

(57) ABSTRACT

An RFID handheld device is connected at an antenna input to an RFID reading apparatus for the stationary installation at a reading zone, said RFID handheld device having a trigger switch as well as a first antenna and an antenna connector connected to the first antenna so that an RFID signal received by the RFID handheld device, but not evaluated there, can be supplied to the receiver via the antenna input. On actuating a trigger switch at the RFID handheld devices, a trigger signal can be transmitted to the evaluation unit which then carries out a reading procedure via the first antenna.

### BACKGROUND

1. Field

This disclosure relates to an RFID reading apparatus having an antenna input, a receiver connectable to the antenna input for receiving RFID signals and an evaluation unit for reading RFID information from received RFID signals

2. Background

RFID reading systems serve for the identification of objects and goods and are used inter alia to automate logistical movements. RFID transponders fastened to the goods are read out at an identification point, for example on a change of the owner of the good or on a change of the transport means; and information is optionally written back into the transponder. This results in fast and traceable logistical movements. The detected information is used to control the forwarding and sorting of goods and products. Important applications for automatic identification are logistical distribution centers, for instance of package shippers, or the baggage check-in at airports.

Such transponders can basically be active; that is, have their own energy supply and generate electromagnetic radiation independently. In practice, however, these transponders are less suitable for logistics because the unit prices for such transponders cannot reach the low level required for the mass market due to the energy supply. Passive transponders without their own energy supply are therefore usually used. In both cases, the transponder is excited to radiate the stored information by electromagnetic radiation of the reading device, with passive transponders taking the required energy from the transmission energy of the reading system. In the established ultra-high frequency standard ISO 18000-6, passive transponders are read out using the backscatter process.

A frequent deployment site of an RFID reading system is the installation at a conveyor belt on which the goods are conveyed or in a so-called reading portal. Any desired passageway is to be understood by this which is equipped with one or more RFID readers and possibly with further sensors. Objects are moved through the reading portal by means of a conveyor belt, by means of a transport vehicle such as a forklift, or also manually and are in so doing identified with respect to their RFID transponder. In this respect, the reading takes place automatically with the aid of fixedly installed antennas. If the information cannot be detected automatically, a manual post-identification is carried out. In this respect, information independent of RFID is used for some objects such as an optical code or an address field.

RFID handheld devices are known which are brought into the vicinity of a transponder to read it. These RFID handheld devices are full RFID readers, including a transceiver and evaluation. In addition, a higher-ranking unit is necessary which receives the read-out information and links reading results of the RFID handheld device and other RFID reading devices. If therefore such an RFID handheld device is used for the post-identification, substantial costs arise for the RFID handheld device itself and for its integration into the reading portal.

An RFID system having improved communication between its components is known from US 2010/0123559 A1. A type of RFID repeater is provided for this purpose which is equipped with two antennas and which thus receives the signal of an RFID transponder and forwards it to an RFID reader, or vice versa. In an embodiment, the RFID repeater is equipped with a push button and with an antenna booster switched by it.

US 2010/0245053 A2 discloses an RFID reading apparatus having a respective series of antenna connectors for transmitter antennas and receiver antennas which are selectively addressed via a respective multiplexer.

### SUMMARY

It is therefore the object of the disclosed subject matter to increase the overall reading rate of an RFID reading system.

This object is satisfied by an RFID reading apparatus having a trigger input and the RFID handheld device has a trigger output connected to the trigger switch, wherein the antenna connector is connected to the antenna input and the trigger input is connected to the trigger output via a respective line or via a common line and, on actuation of the trigger switch, a trigger signal can be transmitted to the evaluation unit which then carries out a reading procedure via the first antenna.

The present disclosure relates to an RFID reading apparatus having an antenna input, a receiver connectable to the antenna input for receiving RFID signals and an evaluation unit for reading RFID information from received RFID signals, wherein an RFID handheld device is connected to the antenna input and has a trigger switch as well as a first antenna and an antenna connector connected to the first antenna so that an RFID signal received by the RFID handheld device, but not evaluated there, can be supplied to the receiver via the antenna input, and to a method for reading RFID information.

In a further aspect the present disclosure relates to method of reading RFID information from an RFID transponder, wherein RFID transponders in an RFID reading apparatus installed as stationary are read automatically using at least one internal antenna or external antenna of the RFID reading apparatus when an object carrying the transponder is located in a reading zone of the RFID reading apparatus, wherein a trigger signal is transmitted to an evaluation unit of the RFID reading apparatus for the post-identification of RFID transponders not read automatically by actuation of a trigger switch at an additional RFID handheld device, whereupon the evaluation unit carries out a reading procedure of the RFID reading apparatus via an antenna of the RFID handheld device in which an RFID signal of the RFID transponder is received via the antenna of the RFID handheld device, is forwarded to the RFID reading apparatus by the RFID handheld device via an antenna line without evaluation and is then evaluated in the evaluation unit spatially separate from the RFID handheld device.

The technique can be further developed in a similar manner and shows similar advantages in so doing. Such advantageous features are described in an exemplary, but not exclusive manner by providing an antenna booster between the first antenna and the antenna connector, by using one or more additional antennas, or by using a multiplex unit to selectively connect the receiver to the first and second antennas. The technique can use the trigger signal to trigger a reading via the first antenna and/or via the second antenna. The evaluation unit can be configured to combine reading results from reading attempts received via different antennas with one another.

### BRIEF DESCRIPTION OF THE DRAWINGS

The present disclosure will be explained in more detail in the following also with respect to further features and advantages by way of example with reference to embodiments and to the enclosed drawing. The Figures of the drawing show, in:

FIG. 1—a schematic sectional representation of an RFID handheld device.

FIG. 2—a block diagram of an RFID reading device with a connected RFID handheld device.

FIG. 3—a representation of the exemplary installation of an RFID reading device at a conveyor belt with a connected RFID handheld device for post-identification.

### DETAILED DESCRIPTION

Overview

The present disclosure starts from the basic idea of utilizing an extremely simple handheld device for the post-identification which has an antenna and which can be connected to an RFID reading apparatus via an antenna connector. The handheld device thus forwards the antenna signal directly without evaluating it itself. A simple analog processing of the antenna signal in the handheld device, such as boosting or filtering at a frequency range of the RFID signals, is conceivable. A reading of the RFID information does not, however, take place in the handheld device and no evaluation function required for this is even present in the handheld device.

The disclosed subject matter has the advantage that the post-identification is facilitated by the handheld device. Finally failing reading attempts are then practically only due to defective transponders so that the overall reading rate becomes very high. In this respect, the handheld device remains extremely simple in design and is therefore very inexpensive. Since the handheld device acts like an antenna from the point of view of the system to which it is connected, no far-reaching adaptations are required there for integrating the information of the post-identification.

An antenna booster is preferably provided between the first antenna and the antenna connector. This makes it possible also to connect the handheld device with long antenna lines to a higher-ranking system since the signal losses are compensated by the boosting.

The RFID handheld device has a trigger output and a trigger switch on whose actuation a trigger signal is provided to the trigger output. The RFID handheld device can thereby be connected via a trigger line to an RFID reading system in order to directly fix the points in time for a post-identification. The antenna of the handheld device can thus, for example, be acted on by a carrier signal which the transponder uses to radiate its RFID signal back or to emit it. The trigger signal is preferably a binary switch signal.

The RFID reading apparatus in accordance with the present disclosure for the stationary installation at a reading zone of a conveyor or of a reading portal for reading at least one RFID transponder moved on the conveyor or through the reading portal has an antenna input, a receiver connectable to the antenna input for receiving RFID signals and an evaluation unit for reading RFID information from received RFID signals. An RFID handheld device is connected to the antenna input and has a first antenna and an antenna connector connected to the first antenna so that an RFID signal received by the RFID handheld device, but not evaluated there, can be supplied to the receiver via the antenna input. The RFID handheld device can be designed in accordance with any desired embodiment in accordance with the present disclosure. The reading portal is in particular a reading tunnel having an electromagnetic shielding unit which protects the reading zone from electromagnetic interference radiation. The handheld device is then preferably used outside the shielding unit after the objects have left the reading tunnel, but was not yet able to be fully identified there. It can be connected via its antenna output or the antenna input of the reading apparatus to the latter's receiver, either constantly or at times, for instance, with the aid of a switch.

The RFID reading apparatus has a trigger input, wherein the RFID handheld device has a trigger output and a trigger switch connected to the trigger input such that, on actuation of the trigger switch, a trigger signal can be transmitted to the RFID reading apparatus. The handheld device is thus directly activated for post-identifications at specific reading intervals.

The RFID reading apparatus preferably has at least one second antenna. The second antenna is an antenna of the reading apparatus which is independent of the handheld device. It can be integrated into a housing of the reading apparatus as an internal antenna or it can be connected via a further antenna line as an external antenna. The second antenna can furthermore be the antenna of an additional handheld device in accordance with the present disclosure. In an analog manner, a third antenna and further antennas of the RFID reading apparatus can be provided. The connection of handheld devices not in accordance with the present disclosure having their own antenna and evaluation is possible, but not meant here since such handheld devices are not connected via an antenna cable, but rather via a data line.

The RFID reading apparatus preferably has a multiplex unit to connect the receiver selectively to the first antenna and to the second antenna. The same receiver can thereby be used for two antennas or, if present, also more antennas. In this respect, the respective connection can be switched, whereupon the selected antenna is active for a specific time, or a real multiplexing can be carried out, for example as a time multiplexing with cyclic activation of a plurality of or of all connected antennas in associated time slots.

The trigger signal preferably triggers a reading via the first antenna and/or via the second antenna. The actuation of the trigger switch can therefore effect both a reading via the first antenna of the handheld device and of the RFID reading apparatus itself. The RFID handheld device thus not only serves for the post-identification, but in a certain manner also for the control of the RFID reading apparatus.

The evaluation unit is preferably configured to combine reading results from reading attempts received via different antennas with one another. The RFID signals received via the different antennas are thereby evaluated together, for instance by comparison, plausibility checks or supplementing of RFID information. The advantage of reading via the handheld device in accordance with the present disclosure is that the RFID reading device receives the information as an antenna signal, for which purpose it is anyway equipped to read via its own internal or external antennas and thereby does not need any special function for the integration of the handheld device. With a conventional handheld device, already evaluated information is transmitted which would have to be treated differently than an antenna signal.

### EXAMPLES

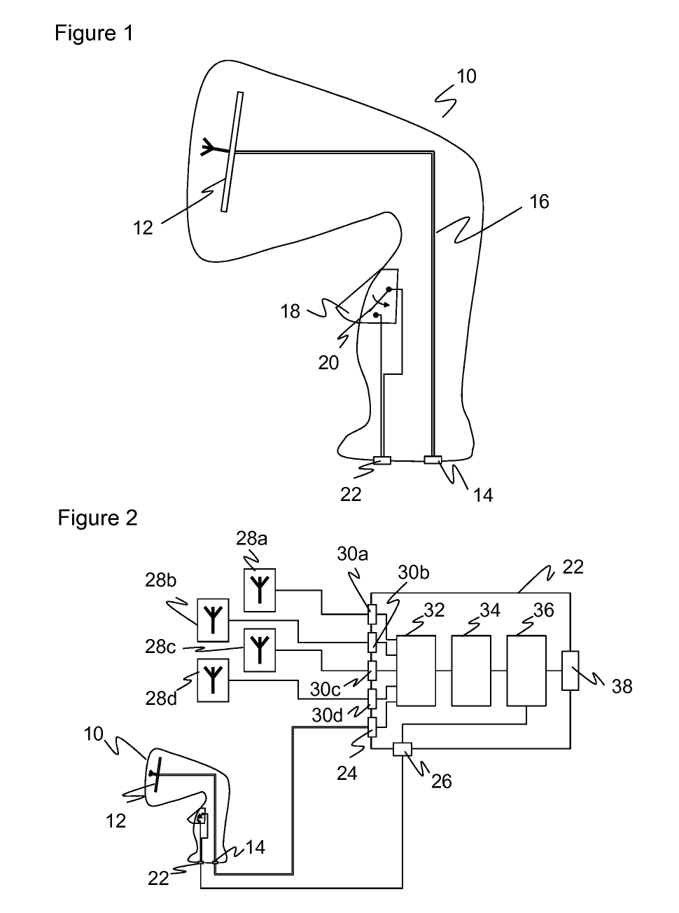

FIG. 1 is a schematic sectional representation of an RFID handheld device. FIG. 1 shows a schematic sectional representation of an RFID handheld device 10. The handheld device 10 has an antenna 12 which is configured, for example, as a patch antenna and which is directly connected to an antenna connector 14. An internal antenna line 16, for example a 50 Ω coaxial line, is provided for this purpose. Due to the direct connection, the handheld device 10 forwards an RFID signal received via the antenna 12 at its antenna connector 14 without any previous evaluation or other processing. It is, however, alternatively conceivable to boost or filter the RFID signal using analog elements, not shown, for example to restrict it to an RFID frequency range.

The handheld device 10 additionally has a trigger 18 which is preferably to be operated using the index finger and on whose actuation a switch 20 is closed. This has the result that a switch signal is provided at a trigger output 22. The trigger signal can be produced with elements, not shown, in the handheld device, but this is preferably done in a higher-ranking system which is connected to the trigger output 22, wherein the closing of the switch 20 only passively provides that the circuit is closed and the switch signal is thus transmitted.

A further embodiment variant is that a further antenna is provided instead of an antenna connector 14 for a wired transmission of the RFID signal. In principle, the existing antenna 12 could also be used for this purpose. The handheld device 10 then practically works as a repeater to forward an RFID signal of a transponder wirelessly. The further antenna can in this respect adopt a specific position and have specific emission properties so that the RFID signal is reliably received in a higher-ranking system.

FIG. 2 is a block diagram of an RFID reading device with a connected RFID handheld device. FIG. 2 shows a block diagram of an RFID reading device 22 with a connected RFID handheld device 10. In this respect, the antenna connector 14 is connected to an antenna input 24 and the trigger output 22 is connected to a trigger input 26 of the RFID reading device 22.

The RFID handheld device 10 acts as a further antenna from the point of view of the RFID reading device 22 due to the connection via the antenna connector 14 and the antenna input 24. In addition, the RFID reading device 22 has any desired number of external or internal antennas 28a-d at further antenna connectors 30a-d which can also belong to a further handheld device 10. The antennas 12, 28a-d are connected via a multiplexer 32 in FIG. 2 so that they are addressed cyclically and are connected to a receiver 34. Alternatively, dedicated lines and, for example, a multichannel design of the receiver 34 without a multiplexer 32 are also conceivable.

The respective received RFID signal is evaluated in an evaluation unit 36 to read the information transmitted by the transponder. This takes place according to any desired known RFID standard and will not be explained further here. The information can then be output at a data interface 38.

Depending on the RFID standard, it is necessary to transmit a carrier signal for reading a transponder or there is a possibility of writing information to a transponder. The transmission of RFID signals is then bidirectional; i.e., the antenna 12 can also be used for transmitting. For this purpose, a transmitter is used in addition to the receiver 34 or the receiver 34 is configured as a transceiver.

The RFID handheld device 10 is preferably not constantly active as an antenna, but only on actuation of the trigger 18. The trigger signal is transmitted to the evaluation unit 36 which then carries out a reading procedure via the antenna 12. Alternatively, a reading procedure of the total RFID reading apparatus 22 is triggered, that is only via one antenna, or also via some or all antennas 28a-d. The evaluation unit 36 is able to combine the RFID information received via the various antennas 12, 28a-d, that is, for example, to supplement it, to compare it or to complete it.

In an alternative embodiment, a separate line for the trigger signal is dispensed with and accordingly a trigger input 22 and a trigger output 26 are dispensed with. Then either the antenna 12 is constantly active or the antenna line is used in dual fashion in order also to transmit the trigger signal via it, for example as a certain pulse pattern or as a signal of a frequency outside the RFID band, whereby the evaluation unit 36 can easily distinguish the trigger signal from an RFID signal.

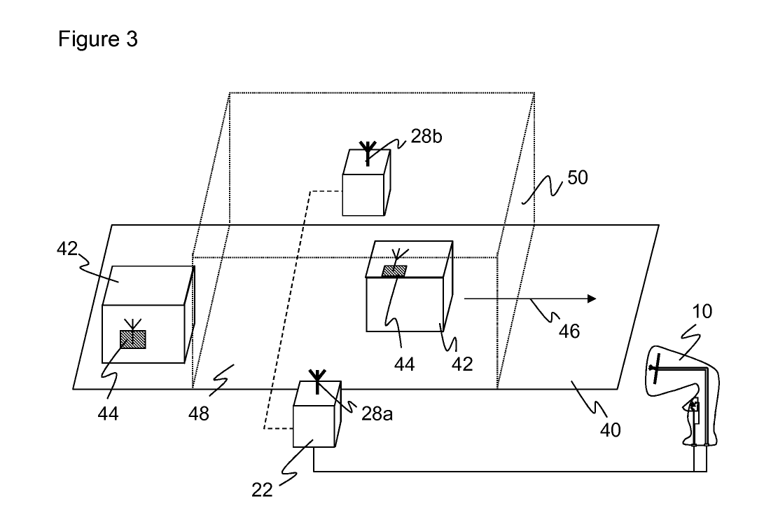

FIG. 3 is a representation of the exemplary installation of an RFID reading device at a conveyor belt with a connected RFID handheld device for post-identification. FIG. 3 shows an overview representation of the installation of an RFID reading apparatus 22 with an RFID handheld device 10 for post-identification at a conveyor 40. Objects 42 having transponders 44 are conveyed through a reading zone 48 in a direction marked by an arrow 46. An electromagnetic shield 50 is provided above the reading zone 48 which is only shown schematically and which provides that, where possible, only RFID signal are received from the reading zone 48 and no interference radiation escapes to the outside. Further conceivable sensors at a reading tunnel which, for example, recognize the entry and departure of objects 42 or which determine volumes or weights of objects 42 are not shown for reasons of clarity.

The RFID reading apparatus 22 in this representation has an internal antenna 28a and an external antenna 28b arranged opposite, which is only one example for any desired antenna configuration. The transponders 44 are automatically read using these antennas 28a-b when the associated object 42 is located in the reading zone 48. The RFID handheld device serves to read transponders 44 of objects 42 in a manual post-processing if the automatic identifications were not sufficient for whatever reason.

### CONCLUSION

It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. An RFID reading apparatus for the stationary installation at a reading zone of a conveyor or of a reading portal for reading at least one RFID transponder moved on the conveyor or through the reading portal, wherein the RFID reading apparatus has an antenna input, a receiver connectable to the antenna input for receiving RFID signals and an evaluation unit for reading RFID information from received RFID signals, wherein an RFID handheld device is connected to the antenna input and has a trigger switch as well as a first antenna and an antenna connector connected to the first antenna so that an RFID signal received by the RFID handheld device, but not evaluated there, can be supplied to the receiver via the antenna input,
wherein the RFID reading apparatus has a trigger input and the RFID handheld device has a trigger output connected to the trigger switch, wherein the antenna connector is connected to the antenna input and the trigger input is connected to the trigger output via a respective line or via a common line and, on actuation of the trigger switch, a trigger signal can be transmitted to the evaluation unit which then carries out a reading procedure via the first antenna.

2. The RFID reading apparatus in accordance with claim 1,
wherein an antenna booster is provided between the first antenna and the antenna connector.

3. The RFID reading apparatus in accordance with claim 1, further comprising at least one second antenna.

4. The RFID reading apparatus in accordance with claim 3, further comprising a multiplex unit to connect the receiver selectively to the first antenna and to the second antenna.

5. The RFID reading apparatus in accordance with claim 3,
wherein the trigger signal triggers a reading via the first antenna and/or via the second antenna.

6. The RFID reading apparatus in accordance with claim 3,
wherein the evaluation unit is configured to combine reading results from reading attempts received via different antennas with one another.

7. A method of reading RFID information from an RFID transponder, wherein RFID transponders in an RFID reading apparatus installed as stationary are read automatically using at least one internal antenna or external antenna of the RFID reading apparatus when an object carrying the transponder is located in a reading zone of the RFID reading apparatus,
wherein a trigger signal is transmitted to an evaluation unit of the RFID reading apparatus for the post-identification of RFID transponders not read automatically by actuation of a trigger switch at an additional RFID handheld device, whereupon the evaluation unit carries out a reading procedure of the RFID reading apparatus via an antenna of the RFID handheld device in which an RFID signal of the RFID transponder is received via the antenna of the RFID handheld device, is forwarded to the RFID reading apparatus by the RFID handheld device via an antenna line without evaluation and is then evaluated in the evaluation unit spatially separate from the RFID handheld device.
